(19) United States
(12) Patent Application Publication
(10) Pub. No.: US 2026/0343457 A1
(43) Pub. Date: Oct. 29, 2026

(54) EXCHANGING A NETWORK SLICE INITIATED BY AN ACCESS AND MOBILITY MANAGEMENT FUNCTION

(71) Applicant: Lenovo (Singapore) Pte. Limited, Singapore (SG)

(72) Inventor: Genadi Velev, Darmstadt (DE)

(73) Assignee: Lenovo (Singapore) Pte. Limited, Singapore (SG)

(21) Appl. No.: 19/101,517

(22) PCT Filed: Aug. 4, 2023
(86) PCT No.: PCT/IB2023/057915

§ 371 Date: Feb. 5, 2025

Related U.S. Application Data
(60) Provisional application No. 63/395,436, filed on Aug. 5, 2022.

(51) Int. Cl. H04W 60/00; H04W 48/18; H04W 76/10

(52) U.S. Cl. CPC H04W 60/00; H04W 48/18; H04W 76/10

(57) ABSTRACT

Various aspects of the present disclosure relate to exchanging a network slice initiated by an access and mobility management function (AMF). An apparatus determines that a first network slice is no longer available and can be exchanged for a second network slice, and transmits a configuration update to a user equipment (UE) registered with the first network slice. The configuration update includes a mapping of the second network slice to the first network slice. The UE receives the configuration update to change from the first network slice being used for one or more protocol data unit (PDU) sessions to the second network slice, and the UE transmits a new PDU session establishment request on the second network slice based on a determination by the UE to establish the new PDU session.

### RELATED APPLICATION

This application claims priority to U.S. Provisional Application Ser. No. 63/395,436 filed Aug. 5, 2022 entitled “Exchanging a Network Slice Initiated by an Access and Mobility Management Function,” the disclosure of which is incorporated by reference herein in its entirety.

### TECHNICAL FIELD

The present disclosure relates to wireless communications, and more specifically to exchanging (e.g., switching, updating, modifying) a network slice.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communications system, such as time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Network slicing enables a network operator to divide a network into granular “slices” to provide customized network connectivity or features for customer devices and/or external service providers. A network slice is a logical network that has a set of network functions and corresponding resources (e.g., computing, storage, networking) to provide certain network capabilities and network characteristics. A network slice can include the core network control plane and user plane network functions, as well as an access network (e.g., 5G radio access network or fixed access network). A UE can be configured with network slice relevant information, which is network slice selection assistance information (NSSAI), which may include single or multiple S-NSSAIs (single NSSAIs).

### SUMMARY

The present disclosure relates to methods, apparatuses, and systems that support exchanging a network slice initiated by an access and mobility management function (AMF). By utilizing the described techniques, a first network slice (S-NSSAI-1) can be exchanged for a second network slice (S-NSSAI-2), such as when the AMF determines that the first network slice is no longer available and can be exchanged for the second network slice. The AMF transmits a configuration update to a UE registered with the first network slice, and the configuration update includes a mapping of the second network slice to the first network slice. The UE receives the configuration update to change from the first network slice currently is use for one or more PDU sessions to the second network slice, and the configuration update includes the mapping of the second network slice to the first network slice. The UE transmits a new PDU session establishment request on the second network slice based on a determination by UE to establish the new PDU session.

By performing aspects of the described exchanging a network slice initiated by AMF, the AMF triggers a UE network slice re-configuration after determining that the first network slice becomes unavailable and a new, second network slice is not part of the UE subscribed S-NSSAIs and/or configured NSSAI (i.e., is not part of the URSP rules, and thus, the second network slice cannot be used by the UE for PDU session establishment). The AMF provides a new configured NSSAI, including the second network slice and a corresponding mapping information of the second network slice (S-NSSAI-2) to the first network slice (S-NSSAI-1) (in a non-roaming case) or home public land mobile network (HPLMN) S-NSSAI (in a roaming case) in order to allow the UE to continue using the one or more URSP rules. The configured and/or allowed NSSAI mapping information of S-NSSAI-2 to S-NSSAI-1 (or to HPLMN S-NSSAI) is used to configure the UE to start using a PDU session on the second network slice instead of on the first network slice. Further benefit is that the AMF first configures the UE via a NAS MM procedure to use the alternative, second network slice, and afterwards, the AMF triggers the session management (SM) procedure to the session management function (SMF) to release the old PDU session. This allows the UE to immediately trigger a new PDU session establishment without a need to perform the NAS MM procedure.

In some implementations of the method and apparatuses described herein, the AMF determines that a first network slice is no longer available and can be exchanged for a second network slice. The AMF transmits a first signaling indicating a configuration update to a UE registered with the first network slice, and the configuration update includes a mapping of the second network slice to the first network slice.

Some implementations of the method and apparatuses described herein may further include the second network slice is not a UE subscribed network slice and is not identified in configured NSSAI. The configuration update to the UE includes updated or allowed configured NSSAI including the mapping of the second network slice to the first network slice. The AMF transmits a second signaling to a network session management function explicitly indicating to release one or more protocol data unit (PDU) sessions associated with the first network slice. The AMF receives a second signaling from the UE as a PDU session establishment request on the second network slice. The PDU session establishment request includes the mapping of the second network slice to the first network slice, which the apparatus does not transmit to a network session management function. The AMF transmits a second signaling to a network data management function indicating a request to exchange the first network slice with the second network slice based at least in part on the determination that the first network slice is no longer available, and receives a third signaling from the network data management function identifying the second network slice to replace the first network slice. The second signaling to the network data management function initiates the network data management function to perform a network slice subscription update procedure.

In some implementations of the method and apparatuses described herein, a UE receives a first signaling indicating a configuration update to change from a first network slice being used for one or more PDU sessions to a second network slice, and the configuration update includes a mapping of the second network slice to the first network slice. The UE transmits a second signaling as a new PDU session establishment request on the second network slice based at least in part on a determination by the apparatus to establish the new PDU session.

Some implementations of the method and apparatuses described herein may further include the UE identifies an absence of the second network slice in configured NSSAI. The UE releases the one or more PDU sessions based on the configuration update received to change from the first network slice to the second network slice. The UE implicitly releases the one or more PDU sessions without subsequent signaling. The UE releases the one or more PDU sessions after the new PDU session is established.

### BRIEF DESCRIPTION OF THE DRAWINGS

FIG. 1 illustrates an example of a wireless communications system that supports exchanging a network slice initiated by AMF in accordance with aspects of the present disclosure.

FIG. 2 illustrates an example 5GS architecture for a UE associated with two network slices, which supports exchanging a network slice initiated by AMF in accordance with aspects of the present disclosure.

FIGS. 3A and 3B illustrate an example of a signaling flow diagram 300 for an AMF determining to reconfigure a UE with an alternative, second network slice, which supports exchanging a network slice initiated by AMF in accordance with aspects of the present disclosure.

FIGS. 4 and 5 illustrate an example of a block diagram of devices that supports exchanging a network slice initiated by AMF in accordance with aspects of the present disclosure.

FIGS. 6 through 9 illustrate flowcharts of methods that support exchanging a network slice initiated by AMF in accordance with aspects of the present disclosure.

### DETAILED DESCRIPTION

A network operator can divide a network into network slices to provide customized network connectivity or features for customer devices and/or external service providers. A network slice is a logical network with a set of network functions and corresponding resources (e.g., computing, storage, networking) to provide certain network capabilities and network characteristics. A network slice can include the core network control plane and user plane network functions, as well as an access network. A UE can be configured with network slice configuration information, NSSAI, which may include single or multiple S-NSSAIs (single NSSAIs).

A network slice that is being used by a UE may be changed to another network slice (e.g., slice remapping), such as during UE mobility due to a lack of support of a first network slice in the target cell, or due to resource limitations of the first network slice in the target radio access network (RAN) node. However the drawback of conventional techniques is that slice remapping is performed transparently to the UE non-access stratum (NAS) layer, or even transparent to the UE access stratum (AS) layer. The slice remapping is performed in the RAN side without altering the UE NAS layer or 5G core network (5GCN or 5GC). However, a change of the network slice will change the UE because the UE needs to be reconfigured with the alternate network slice, which is exchanged for the first network slice. Another conventional technique suggests that the SMF communicates the alternative network slice to the UE in the NAS SM signaling. However, this does not account for how the UE would process an alternative network slice for different PDU sessions on a previous network slice.

In aspects of the described disclosure, there are several scenarios as to how an alternative or second network slice (S-NSSAI-2) relates to a UE subscribed S-NSSAI(s) list stored in the UE subscription data and in the UE context in AMF. In a first scenario, the second network slice is part of the subscribed S-NSSAIs and is already part of the allowed NSSAI. In a second scenario, the second network slice is part of the subscribed S-NSSAIs, but is not part of the allowed NSSAI, and the second network slice can be added to the allowed NSSAI because it is supported in the current tracking area (TA). In a third scenario, the second network slice is part of the subscribed S-NSSAIs, but the second network slice cannot be added to the allowed NSSAI because it is not supported in the UE current TA, or is rejected due to another reason (e.g., due to NSSAI failure). A new, alternative network slice (S-NSSAI) is then required, which may not be part of the subscribed S-NSSAIs. In a fourth scenario, the second network slice is not part of the subscribed S-NSSAIs and configured NSSAI (in a non-roaming case) or is not part of the configured NSSAI (in a roaming case). The UE cannot request and use the second network slice (S-NSSAI-2) unless it is not part of the UE configured NSSAI.

By performing aspects of the described exchanging a network slice initiated by AMF, the AMF triggers a UE network slice re-configuration after determining that the first network slice becomes unavailable and a new, second network slice is not part of the UE subscribed S-NSSAIs and/or configured NSSAI (i.e., is not part of the URSP rules, and thus, the second network slice cannot be used by the UE for PDU session establishment). The AMF provides a new configured NSSAI, including the second network slice and a corresponding mapping information of the second network slice (S-NSSAI-2) to the first network slice (S-NSSAI-1) (in a non-roaming case) or HPLMN S-NSSAI (in a roaming case) in order to allow the UE to continue using the one or more URSP rules. The configured and/or allowed NSSAI mapping information of S-NSSAI-2 to S-NSSAI-1 (or to HPLMN S-NSSAI) is used to configure the UE to start using a PDU session on the second network slice instead of on the first network slice. Further benefit is that the AMF first configures the UE via a NAS MM procedure to use the alternative, second network slice, and afterwards, the AMF triggers the SM procedure to the SMF to release the old PDU session. This allows the UE to immediately trigger a new PDU session establishment without a need to perform the NAS MM procedure.

Aspects of the present disclosure are described in the context of a wireless communications system. Aspects of the present disclosure are further illustrated and described with reference to device diagrams and flowcharts.

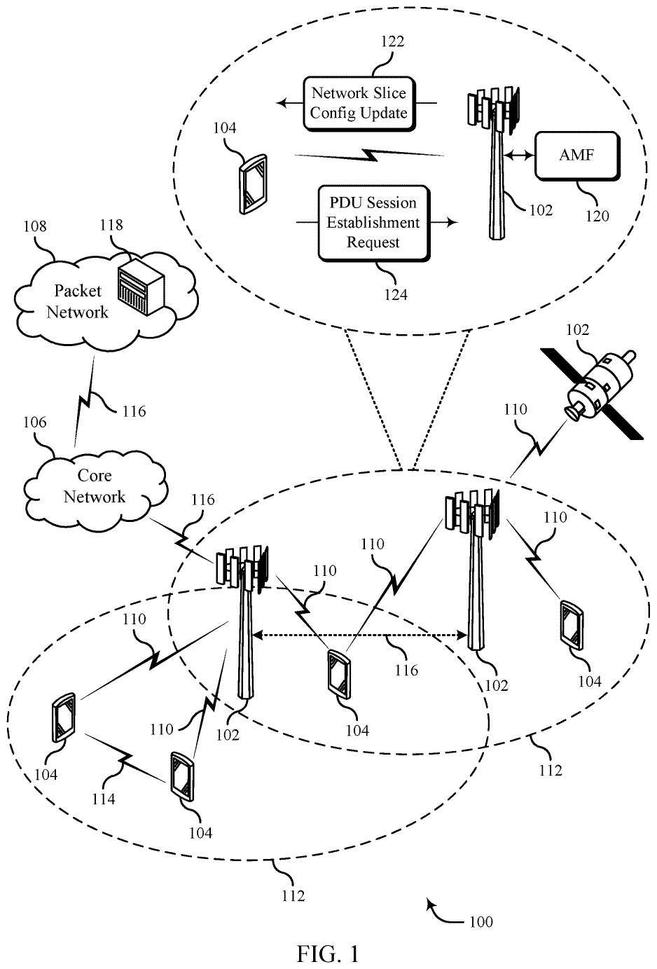

FIG. 1 illustrates an example of a wireless communications system 100 that supports exchanging a network slice initiated by AMF in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IOT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage NAS functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100, such as time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHz-24.25 GHZ), FR4 (52.6 GHz-114.25 GHZ), FR4a or FR4-1 (52.6 GHz-71 GHZ), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR 2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the network entities 102 (to include access network), the UEs 104, an AMF 120, and/or SMFs are operable to implement various aspects of exchanging a network slice initiated by AMF, as described herein. For instance, the AMF 120 determines that a first network slice is no longer available and can be exchanged for a second network slice, and the AMF transmits a network slice configuration update 122 to the UE 104 that is registered with the first network slice. In an implementation, the network slice configuration update 122 includes a mapping of the second network slice to the first network slice. The UE 104 receives the network slice configuration update 122 from the AMF 120 (via network entity 102) that indicates to change from the first network slice being used for one or more PDU sessions to the second network slice. The UE then transmits a new PDU session establishment request 124 on the second network slice based on a determination by the UE to establish the new PDU session, which is received by the AMF 120.

Generally, a UE requests registration to network slices by communicating, to the 5GC (e.g., AMF) a NAS registration request message including a requested NSSAI containing a list of one or more S-NSSAIs to which the UE wants to register. The AMF communicates to the UE, in the registration acceptance message or in a UE configuration update command message, one or more elements related to the network slice configuration of the UE, such as allowed NSSAI, configured NSSAI, rejected NSSAI, or pending NSSAI. The NSSAI is a list of one or more S-NSSAIs.

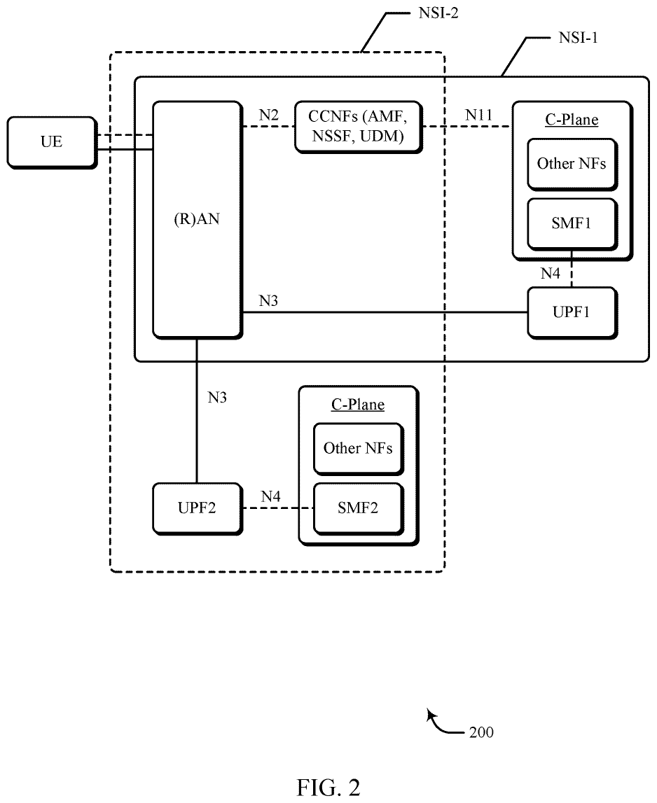

FIG. 2 illustrates an example 5GS architecture 200 for a UE associated with two network slices, which supports exchanging a network slice initiated by AMF in accordance with aspects of the present disclosure. The UE is associated with two network slices that are deployed correspondingly over a first network slice instance (e.g., “NSI-1” depicted in a solid line) and a second network slice instance (“NSI-2” depicted in dashed line). According to this example architecture 200, the (radio) access network ((R)AN) is part of the two network slices and is shared. The core network of the network slices (or NSIs) has common control plane network functions (CCNFs) and dedicated CN network functions, such as SMF1, user plane function (UPF)1, and other network functions (NFs) belonging to NSI-1, and SMF2, UPF2, and other network functions (NFs) belonging to NSI-2. Note that the example 5GS architecture 200 does not show or include all of the network functions (e.g., AMF, network slice selection function (NSSF), SMF, UPF, etc.) or all of the reference points.

The support of network slice service continuity during UE mobility due to a lack of support for a network slice, or resource limitations of the network slice in the target RAN node, are considered. These scenarios may occur due to network slices not being required to be available in all tracking areas (TAs) of a network. In aspects of this disclosure, a non-mobility scenario (or event) and a mobility scenario (or event) in the network are taken into consideration, which results in a change of a network slice. For the non-mobility scenario, a network slice (or network slice instance) is overloaded or undergoing planned maintenance in CN (e.g., network slice termination) and/or b) network performance of the network slice cannot meet the service level agreement (SLA) as agreed with the network slice customer, and therefore the UE should use an alternate network slice to fulfil the SLA. The mobility scenario is considered, particularly in the event of inter-registration area (RA) mobility where a network slice (or network slice instance) is overloaded in the target CN.

Aspects of the present disclosure take into account whether a current network slice (or network slice instance) can serve the PDU session, or whether the current network slice instance can meet the performance requirements of the applications. If a possible alternative S-NSSAI is not part of a UE subscribed S-NSSAIs (stored in the UE context in the AMF), then the alternative S-NSSAI is also not part of the UE configured NSSAI and URSP rules. The UE cannot request registration to an alternative S-NSSAI. Aspects of the present disclosure consider allowing the UE to register with an alternative S-NSSAI which is not part of the UE configured NSSAI. Further, aspects of the present disclosure consider how to assure that an alternative S-NSSAI (e.g., S-NSSAI-2) is compatible with the UE network slice configuration and routing policy (e.g., NSSP/URSP, configured NSSAI, and/or allowed NSSAI).

When a network slice that is used by a UE changes to another network slice, this network slice change is referred to as a slice remapping, such as during UE mobility due to a lack of support of a first network slice in the target cell or resource limitations of the first network slice in the target RAN node. However the drawback of conventional techniques is that slice remapping is performed transparently to the UE NAS layer, or even transparent to the UE AS layer. In other words, slice remapping is performed in the RAN side without altering the UE NAS layer or 5G core network (5GCN or 5GC). However, in the above described scenarios, a change of the network slice will change the UE and 5GC because the UE needs to be reconfigured with the alternate network slice, which is exchanged for the first network slice. Another conventional technique suggests that the SMF communicates the alternative S-NSSAI to the UE in the NAS SM signaling. However, this does not account for how the UE would process an alternative S-NSSAI for different PDU sessions on a previous S-NSSAI (e.g., S-NSSAI-1).

In aspects of the described disclosure, there are several scenarios as to how an alternative or second network slice (S-NSSAI-2) relates to a UE subscribed S-NSSAI(s) list stored in the UE subscription data and in the UE context in AMF. The various scenarios can include: a) the S-NSSAI-2 is part of the subscribed S-NSSAIs and is already part of the allowed NSSAI; b) the S-NSSAI-2 is part of the subscribed S-NSSAIs, but is not part of the allowed NSSAI, and the S-NSSAI-2 can be added to the allowed NSSAI because the S-NSSAI-2 is supported in the current tracking area (TA); c) the S-NSSAI-2 is part of the subscribed S-NSSAIs, but the S-NSSAI-2 cannot be added to the allowed NSSAI because the S-NSSAI-2 is not supported in the UE current TA, or is rejected due to another reason (e.g., due to NSSAA failure). A new alternative S-NSSAI would then be required, which may not be part of the subscribed S-NSSAIs; and d) the S-NSSAI-2 is not part of the subscribed S-NSSAIs and configured NSSAI (in a non-roaming case) or is not part of the configured NSSAI (in a roaming case). The UE cannot request and use S-NSSAI-2 unless the S-NSSAI-2 is not part of the UE configured NSSAI.

Aspects of this disclosure describe how the network slice S-NSSAI-2 can replace the network slice S-NSSAI-1 in the scenarios described above, particularly in the scenario d), which encompasses scenario c). In the scenarios a) and b), it is assumed that the alternative S-NSSAI-2, which is going to replace the S-NSSAI-1, is part of the UE subscribed S-NSSAIs. Therefore, the alternative S-NSSAI-2 would be configured in the UE URSP rule, specifically in the URSP rule which is used to establish the current PDU session(s) on S-NSSAI-1, if the S-NSSAI-2 is allowed to be used for application data traffic. Hence, there is no need for the SMF to indicate any alternative S-NSSAI-2 to the UE in the NAS SM signaling for PDU session releases.

Aspects of the disclosure are directed to the AMF determines an alternative S-NSSAI-2 that is supported in the current tracking area and which is to replace S-NSSAI-1, and the AMF determines that the S-NSSAI-2 is not part of UE subscribed S-NSSAIs and/or configured NSSAI for the current PLMN. If the AMF is in the HPLMN and the AMF determines that S-NSSAI-2 should replace the S-NSSAI-1 for a relatively longer time period (or for always), then the AMF indicates to the UDM that the list of subscribed S-NSSAIs should change. The UDM triggers the known procedure for network slice subscription change in order to update the UE and the rest of the 5GS. If the AMF determines that S-NSSAI-2 should replace the S-NSSAI- 1, such as on a temporary basis or for a relatively short time period, then the AMF determines to apply a S-NSSAI mapping feature for the UE network slice configuration (i.e., the S-NSSAI-2 is mapped to S-NSSAI-1 and sent to the UE in the configured NSSAI and/or allowed NSSAI).

After the S-NSSAI-2 is part of allowed NSSAI and the mapping information includes mapping S-NSSAI-2 to S-NSSAI-1, the UE automatically initiates a new PDU session(s) establishment procedure using S-NSSAI-2 for each of the current PDU session(s) established on S-NSSAI-1. The AMF receives the PDU session establishment request message, including the S-NSSAI-2 and mapping information of S-NSSAI-2 to S-NSSAI-1, and the AMF determines to remove the mapping information of S-NSSAI-2 to S-NSSAI-1 before forwarding the message to the SMF selected for the S-NSSAI-2. When the S-NSSAI-1 can be used again by the UE, the AMF creates a configured NSSAI to delete the mapping information S-NSSAI-2 to S-NSSAI-1, and the AMF triggers a UE configuration update (UCU) procedure to send the updated configured NSSAI to the UE.

As described herein, the term “alternative” S-NSSAI feature (or “compatible” S-NSSAI feature) means functionality supported by the network and UE, where a first S-NSSAI of a PDU session can be exchanged with another (second) S-NSSAI, where the second S-NSSAI may or may not be included in the UE configured NSSAI. In an implementation, the second S-NSSAI is not part of the UE configured NSSAI, and therefore, the network determines and configures the UE, a second S-NSSAI which (a) replaces the first S-NSSAI (e.g.,, in a roaming case) or (b) maps to the first S-NSSAI (e.g., in a non-roaming case). Additionally, a second S-NSSAI replaces the first S-NSSAI in the network (e.g.,, the first S-NSSAI-1 is pending being replaced or exchanged with the second S-NSSAI-2). It is assumed that the UE has already established a PDU session, and due an event, the current PDU session has to be transferred from a first network slice (S-NSSAI-1) to a second network slice (S-NSSAI-2).

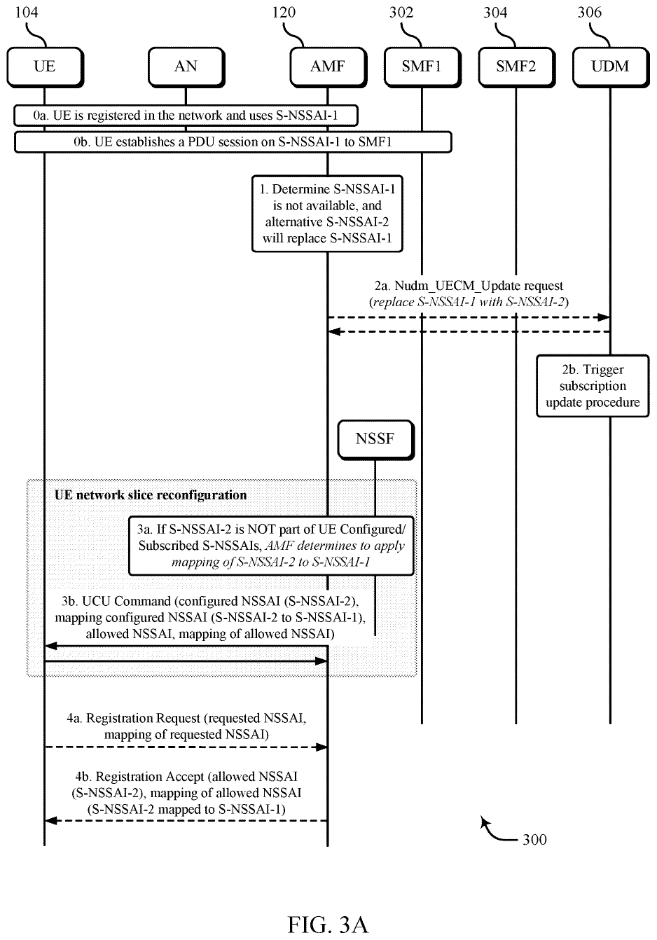

FIGS. 3A and 3B illustrate an example of a signaling flow diagram 300 that supports exchanging a network slice initiated by AMF in accordance with aspects of the present disclosure. The example signaling flow diagram 300 illustrates an AMF determining to reconfigure the UE with an alternative second S-NSSAI (e.g., S-NSSAI-2) by using network slice mapping information. The SMF1 302 is part of the network slice identified by the S-NSSAI-1, whereas the SMF2 304 is part of the network slice identified by the S-NSSAI-2.

In the example signaling flow diagram 300, the UE requests registration with the network (at step Oa), specifically to register with a first network slice (e.g., S-NSSAI-1). The UE initiates (at step Ob) the establishment of a PDU session on S-NSSAI-1, and the SMF1 302 is selected by the AMF 120 to be the serving SMF for the PDU session. The AMF determines (at step 1) that (a) S-NSSAI-1 becomes unavailable and/or (b) an alternative S-NSSAI (e.g., S-NSSAI-2) can be used to replace S-NSSAI-1. The reason why S-NSSAI-1 becomes unavailable can be due to a non-mobility event (e.g., operation, administration, and maintenance (OAM) or NSSF/NF reconfiguration, or S-NSSAI-1 will be down due to network maintenance); or a UE mobility event (e.g., the T-AMF does not support S-NSSAI-1).

The AMF processes the determined alternative S-NSSAI (e.g., S-NSSAI-2) against the network slice configuration (i.e., configured NSSAI, allowed NSSAI, rejected NSSAIs) of the UE. Note that the UE context in the AMF may contain multiple lists of rejected NSSAIs (e.g., rejected NSSAI for the current PLMN or stand-alone non-public network (SNPN), rejected NSSAI for the current registration area, rejected NSSAI for the failed or revoked NSSAA, or rejected NSSAI for the maximum number of UEs reached). If the AMF determines that the S-NSSAI-2 is part of the UE subscribed S-NSSAIs or part of the configured NSSAI, but the S-NSSAI-2 is part of the rejected NSSAI for the failed or revoked NSSAA or rejected NSSAI for the maximum number of UEs reached (or other type of rejected NSSAI), then the AMF determines yet another alternative S-NSSAI (e.g., S-NSSAI-3). This allows the UE to immediately start the use of the S-NSSAI-3. Additionally, the AMF can determine whether the alternative S-NSSAI (e.g., S-NSSAI-2 or S-NSSAI-3) is to be used as alternative only for a limited time or permanently (i.e., for a relatively long time) which would result in deciding whether to apply step 2a or step 3a.

If the AMF is in the HPLMN and the AMF determines (at step 2a) that (i) the S-NSSAI-2 should replace the S-NSSAI-1 for a relatively long time period (or for always) or (ii) that S-NSSAI-2 is to be included in addition to the list of subscribed S-NSSAI, then the AMF determines to indicate to a UDM 306 that the list of subscribed S-NSSAIs should be updated (e.g., indicating that S-NSSAI-2 should exchange the S-NSSAI-1, or that the S-NSSAI-2 should be included in addition) (further description is provided below with reference to step 3a). The UDM (at step 2b) updates internally (and/or further indicates to the unified data repository (UDR)) that the list of subscribed S-NSSAIs of the UE should be updated to include S-NSSAI-2 instead of S-NSSAI-1. The UDM triggers a procedure for network slice subscription update in order to update the UE configuration and the configuration in the other network functions (NFs) in 5 GS (e.g., serving AMF, etc.). By updating the list of subscribed S-NSSAIs, the policy control function (PCF), which creates the UE policy, should create new UE route selection policy (URSP) rules, and the new policy rules should include the NSSP as to how application data traffic can map to the S-NSSAI-2.

If the AMF (optionally together with NSSF and/or OAM system) determines (at step 3a) at least one of the following conditions: i) the S-NSSAI-2 (or S-NSSAI-3) is not part of the UE subscribed S-NSSAIs or part of the configured NSSAI; ii) the S-NSSAI-2 should apply temporarily (i.e., for a limited time or for a limited area); and/or iii) the currently established one or more PDU sessions on S-NSSAI-1 are not in an active state (e.g., the user plane resources like N3 tunnel are not activated); then the AMF determines to configure the UE as follows: (1) in a non-roaming case, the S-NSSAI-2 is added to the configured NSSAI (and in the allowed NSSAI) and additionally, network slice mapping is added to configure the UE to map the S-NSSAI-2 to the S-NSSAI-1, where the S-NSSAI-1 acts as HPLMN S-NSSAI value; (2) in a roaming case the S-NSSAI-2 exchanges the S-NSSAI-1 in the configured NSSAI (and in the allowed NSSAI) and the mapping information includes mapping of the S-NSSAI-2 to the HPLMN S-NSSAI (i.e., instead of mapping of the S-NSSAI-1 to the HPLMN S-NSSAI).

The above described condition i) is a result of processing the determined alternative S-NSSAI (e.g., S-NSSAI- 2 or S-NSSAI 3) against the list of the UE subscribed S-NSSAIs and configured NSSAI. If the determined alternative S-NSSAI (e.g., S-NSSAI- 2 or S-NSSAI 3) is not part of the UE subscribed S-NSSAIs, then either the 5GS includes the alternative S-NSSAI in the UE subscribed S-NSSAIs (step 2a), or the AMF performs a UE network slice reconfiguration procedure in order to update the configured NSSAI in the UE. In the latter case, no URSP rules update is needed (e.g., contrary to steps 2a/2b).

The above described condition ii) is a decision point as to whether the AMF performs step 2a or step 3a. If the alternative S-NSSAI (e.g., S-NSSAI-2) is applied in limited conditions, such as limited time or limited area, then the AMF determines to perform the UE network slice reconfiguration procedure. If the S-NSSAI-2 is to apply permanently (or semi-permanently) with respect to time or location area, then the AMF determines to perform step 2a. The above described condition iii) expresses the time point as to when the AMF triggers the UE network slice reconfiguration procedure. The AMF can wait until the PDU session(s) established on S-NSSAI-1 are in an inactive state (e.g., the UP resources are not established) before initiating the UE network slice reconfiguration procedure. This would allow the UE to establish new PDU sessions and terminate the current PDU sessions while there is no user data traffic to be sent over the PDU session(s).

If the NSSF is responsible to determine the configured NSSAI, allowed NSSAI, and/or rejected NSSAI, then the AMF sends a request message to the NSSF and the request includes an indication that an alternative S-NSSAI to S-NSSAI-1 is required. This new indication is sent in addition to the usual parameters (or informational elements) which are part of the Nnssf_NSSelection_Get request service operation from the AMF to the NSSF (e.g., parameters such as subscribed S-NSSAIs, current tracking area identity (ID), etc.). Based on the received request indicating that an alternative S-NSSAI to S-NSSAI-1 is required, the NSSF determines an S-NSSAI-2 as an alternate network slice used to replace S-NSSAI-1. The NSSF also creates and sends to the AMF a new configured NSSAI and/or allowed NSSAI (e.g., including the S-NSSAI-2) together with associated mapping information of S-NSSAI-2 to S-NSSAI-1.

The AMF triggers the UCU procedure (at step 3b), where the AMF includes a new configured NSSAI containing S-NSSAI-2 and additional mapping information of S-NSSAI-2 to S-NSSAI-1. The AMF may also send a new allowed NSSAI with a corresponding mapping of allowed NSSAI information (containing the mapping of S-NSSAI-2-to S-NSSAI-1). This is valid for a non-roaming case and an example for the configured NSSAI (which also applies analogically to the allowed NSSAI) is as follows: Old configured NSSAI: S-NSSAI-1; Mapping of configured NSSAI: none. New configured NSSAI: S-NSSAI-2; Mapping of configured NSSAI: S-NSSAI-2 to S-NSSAI-1.

For the roaming case, where S-NSSAI-1 is used in the serving visited public land mobile network (VPLMN) and HPLMN S-NSSAI value is used in the HPLMN, then the AMF replaces the S-NSSAI-1 with S-NSSAI-2 value. An example for a roaming case for the configured NSSAI (which also applies analogically to the allowed NSSAI) is as follows: Old configured NSSAI: S-NSSAI-1; Mapping of configured NSSAI: S-NSSAI-1 to HPLMN S-NSSAI. New configured NSSAI: S-NSSAI-2; Mapping of configured NSSAI: S-NSSAI-2 to HPLMN S-NSSAI. Note that the AMF (and/or NSSF) can determine to provide the UE with an updated, allowed NSSAI only (i.e., not updating the configured NSSAI). This is beneficial in cases when the alternative S-NSSAI is supposed to apply only for the ongoing registration to the network (e.g., in the current registration area only). If the configured NSSAI is not updated, the UE would again request the use of the old S-NSSAI (e.g., S-NSSAI-1) when a new registration procedure is performed.

If in step 3b the UE receives a new configured NSSAI without allowed NSSAI, the UE triggers a registration procedure (at step 4a) to register with one or more network slices including S-NSSAI-2. The UE sends to the AMF a registration request message including the requested NSSAI parameter (also referred to as an informational element (IE)) where the requested NSSAI contains at least the S-NSSAI-2. The UE can also send the mapping or requested NSSAI to HPLMN NSSAI values IE. After the S-NSSAI-2 becomes part of the allowed NSSAI, the UE can start the establishment of a PDU session with S-NSSAI-2. The AMF receives the registration request message, including the requested NSSAI, and (at step 4b) the AMF (optionally together with NSSF and/or OAM system) determines the S-NSSAIs (e.g., including S-NSSAI-2) which are supported in the UE current TA and can be included in the allowed NSSAI. The AMF (and/or NSSF) determine to apply mapping of S-NSSAI-2 to S-NSSAI-1. The AMF (and/or NSSF) creates a new allowed NSSAI and sends the allowed NSSAI in the registration accept message to the UE.

Continuing the signaling flow diagram 300 in FIG. 3B, if there are one or more established PDU session(s) on S-NSSAI-1, the AMF (at step 5a) determines to send a request to the SMF1 to trigger a release of the PDU session(s). Note that the AMF triggers the PDU session release procedure, although the S-NSSAI-1 is still part of the mapped, allowed NSSAI IE. The AMF can include a new indication that an explicit release signaling communicated to the UE is needed to indicate to the UE that the current established PDU session can no longer be used. The AMF sends a request message to the SMF1 (at step 5b) to indicate that the PDU session should be released. The AMF invokes the Nsmf PDUSession_ReleaseSMContext service operation to request the release of the PDU session. If the AMF determines that the S-NSSAI-1 is no longer available, but there is an alternative S-NSSAI which can be used to replace the S-NSSAI-1, then the AMF includes a new indication as an explicit release signaling communicated to the UE.

The SMF determines to release the PDU session (at step 5c). The PDU session may be of any session and service continuity (SSC) mode (e.g., SSC mode 1, SSC mode 2, or SSC mode 3). In the case of SSC mode 3, the SMF determines to send the UE a PDU session modification request to re-establish the PDU session on an alternative S-NSSAI. The SMF releases the IP address and/or prefix(es) that were allocated to the PDU session, and releases the corresponding user plane resources in the UPF using N4 signaling (not shown in the signaling flow diagram). In the case of a PDU session of SSC mode 2, when the SMF wants the UE to re-establish the PDU session, the SMF includes 5GSM cause #39“reactivation requested”. The SMF creates N1 SM container to be sent to the UE, including a PDU session release command or PDU session modification request message, including the PDU session ID and 5GSM cause value.

The SMF invokes the Namf_Communication_N1N2MessageTransfer service operation (N1 SM container, N2 information). If the UP connection of the PDU session is active, the SMF shall also include the N2 resource release request (PDU session ID) in the Namf Communication_N1N2MessageTransfer, to release the (R)AN resources associated with the PDU session. The UE acknowledges the reception of the N1 SM container to the SMF. The SMF sends to the AMF (at step 5d) a Nsmf_PDUSession_ReleaseSMContext response message to indicate the successful release signaling towards the UE.

After receiving the new allowed NSSAI including S-NSSAI-2 (i.e., without S-NSSAI-1) and the mapping information of S-NSSAI-2 to S-NSSAI-1 (e.g., in step 3b or 4b), the UE performs (at step 6) at least one of the following a) and/or b). At a), the UE (automatically) triggers the establishment of new PDU session(s) for the user data traffic which is currently routed to the S-NSSAI-1 (e.g., according to the URSP rule having the route selection descriptor (RSD) including S-NSSAI-1) but using the S-NSSAI-2 from the allowed NSSAI. If there are established PDU session(s) on S-NSSAI-1, the UE immediately or automatically triggers the establishment of new PDU session(s) for each of the current established PDU session(s), where the same URSP rule and same RSD may be used, but the new PDU session(s) is requested on the S-NSSAI-2 and are meant to exchange the old PDU session(s) on S-NSSAI-1. The stored URSP rule(s), which include RSD containing S-NSSAI-1, are used to establish PDU sessions on S-NSSAI-2, as indicated according to the mapping of allowed NSSAI information (i.e., mapping of S-NSSAI-2 to S-NSSAI-1). At b), the UE performs an implicit release of the old established PDU session(s) on S-NSSAI-1. The UE releases the old established PDU session(s) after establishing the new PDU sessions on S-NSSAI-2, which would allow to minimize the service interruption when changing the network slices, as the UE can continue to transmit data over the old PDU session during the establishment of the new PDU session.

The UE triggers new PDU session(s) establishment (at step 7a) to S-NSSAI-2, where the UE includes in the NAS message to the AMF, the S-NSSAI-2 and mapping of allowed NSSAI information (i.e., the mapping information of S-NSSAI-2 to S-NSSAI-1). Note that this solution applies in non-roaming and roaming scenarios (i.e., the mapping of allowed NSSAI information is also included in the PDU session establishment a request in a non-roaming scenario). As the PDU session is established on a new S-NSSAI (S-NSSAI-2), for a PDU session of SSC mode 1 and 2, the UE either uses a request type “initial request”, or uses request type “existing”. If the UE uses request type “existing”, the UE include the old PDU session ID. If the UE does not provide the old PDU session ID and the request type “existing” is used, the AMF internally determines that the new PDU session on S-NSSAI-2 is associated with the PDU session on S-NSSAI-1. For a PDU session of SSC mode 3, the UE uses either request type “initial request” or “existing”, which should not have influence on the AMF operation, as the AMF is supposed to select an SMF in the S-NSSAI-2.

The AMF selects a serving SMF for the new PDU session (at step 7b) by using the S-NSSAI-2. The AMF selects SMF2 and forwards the UE request to the SMF2 using the Nsmf PDUSession CreateSMContext request service operation. The SMF2 proceeds with the establishment of the PDU session by using the S-NSSAI-2 as follows: If the SMF2 is in the UE HPLMN (i.e., non-roaming case), the SMF2 uses the mapped S-NSSAI-1 value in the service operation to the UDM to retrieve the UE SM subscription data. The SMF2 does not use the mapped S-NSSAI-1 value as input to select another SMF in the S-NSSAI-1. The SMF2 functions as an anchor SMF for the PDU session. Further, if the SMF2 is in a VPLMN for the UE (i.e., roaming case), the SMF2 may determine to use the mapped S-NSSAI value (i.e., S-NSSAI-1) to select and contact an SMF in the HPLMN to establish a home-routed PDU session. In this case, the PDU session establishment procedure for a roaming scenario would apply, and the SMF2 controls the intermediate UPF and the SMF in the HPLMN serves the anchor UPF (i.e., N9 tunnel is established between the intermediate UPF and the anchor UPF).

If the PDU session is utilized for local break-out (LBO), the SMF2 uses the mapped S-NSSAI-1 value in the service operation to the UDM to retrieve the UE SM subscription data, and the SMF3 does not use the mapped S-NSSAI-1 value as input to select another SMF in the S-NSSAI-1 in the HPLMN. The SMF2 retrieves the UE session management subscription data from the UDM by invoking the service operation with subscriber data management (SDM), Nudm_SDM_Get request, including the parameters of subscription permanent identifier (SUPI), session management subscription data, selected data network name (DNN), S-NSSAI of the mapped S-NSSAI value (which is the S-NSSAI-1), etc. The S-NSSAI of the mapped S-NSSAI value is also used in a non-roaming scenario. The SMF2 acknowledges the establishment of the PDU session to the UE by sending a PDU session establishment response, including the user plane configuration for PDU session configuration.

After some time, the AMF can determine (at step 8) that S-NSSAI-1 can be used again. The AMF sends a UCU command to the UE (at step 9), including a new configured NSSAI and/or new allowed NSSAI similar to step 3b. However, the S-NSSAI-2 would be removed and instead the S-NSSAI-1 is included. In addition, the mapping of configured NSSAI (e.g., including the mapping of S-NSSAI-2 to S-NSSAI-1), and the mapping of the allowed NSSAI (e.g., including mapping of S-NSSAI-2 to S-NSSAI-1) is removed as it is no longer applicable. The UE initiates a new PDU session establishment to S-NSSAI-1 (at step 10). The UE sends a NAS message to the AMF, including a new PDU session ID (and optionally the association with the old PDU session ID), S-NSSAI-1, DNN1, and N1 SM container (PDU session establishment request). In the case of SSC mode 3, the UE also includes the old PDU session ID.

Note that aspects of the described disclosure also apply to scenarios where the UE is registered with the S-NSSAI-1 and there is no PDU session established on S-NSSAI-1. In this case, the network (e.g., AMF) triggers a UE network slice reconfiguration procedure by sending a new configured NSSAI and/or allowed NSSAI with corresponding slice mapping information. The UE uses the configured NSSAI and/or allowed NSSAI when a new PDU session is to be established and associated with the S-NSSAI-1 in the matching URSP rule having an RSD associated with the S-NSSAI-1 (or with HPLMN S-NSSAI in a roaming case).

By performing aspects of the described exchanging a network slice initiated by AMF, the AMF triggers the UE network slice re-configuration (steps 3a and 3b) after determining that the S-NSSAI-1 becomes unavailable and the new alternative S-NSSAI-2 is not part of the UE subscribed S-NSSAIs and/or configured NSSAI (i.e., is not part of the URSP rules, and thus, the S-NSSAI-2 cannot be used by the UE for PDU session establishment). The AMF sends a new configured NSSAI, including the alternative S-NSSAI-2 and the corresponding mapping information of S-NSSAI-2 to S-NSSAI-1 (in a non-roaming case) or HPLMN S-NSSAI (in a roaming case) in order to allow the UE to continue using the one or more URSP rules containing S-NSSAI-1 or HPLMN S-NSSAI. The configured and/or allowed NSSAI mapping information of S-NSSAI-2 to S-NSSAI-1 or HPLMN S-NSSAI is used to configure the UE to start using a PDU session on S-NSSAI-2 instead of S-NSSAI-1. Further benefit is that the AMF first configures the UE via a NAS MM procedure to use the alternative S-NSSAI-2, and afterwards, the AMF triggers the SM procedure to the SMF to release the old PDU session. This allows the UE to immediately trigger a new PDU session establishment without a need to perform the NAS MM procedure.

Further, in aspects of the described exchanging a network slice initiated by AMF, the AMF determines to configure a UE with network slice mapping information for S-NSSAI-2 mapping to S-NSSAI-1, when the AMF determines that the S-NSSAI-2 has to exchange S-NSSAI-1, and the S-NSSAI-2 is not part of the UE subscribed S-NSSAIs. If the AMF is in the HPLMN and the AMF determines that the S-NSSAI-2 should replace the S-NSSAI-1 for a relatively long time period (or for always), the AMF indicates to the unified data management (UDM) that the list of subscribed S-NSSAIs should change. Upon receipt of PDU session establishment request message including the S-NSSAI-2 and mapping information of S-NSSAI-2 to S-NSSAI-1, the AMF determines to remove the mapping information of S-NSSAI-2 to S-NSSAI-1 before forwarding the message to the SMF selected for the S-NSSAI-2. The AMF transmits a request to the NSSF that an alternative S-NSSAI to S-NSSAI-1 is required, and receives a corresponding reply.

Further, in aspects of the described exchanging a network slice initiated by AMF, the UE receives a new allowed NSSAI with mapping information for S-NSSAI-2 mapping to S-NSSAI-1, and the UE determines to automatically trigger the establishment of new PDU session(s) on S-NSSAI-2 for each of the current established PDU session(s) on S-NSSAI-1. The UE also receives a new allowed NSSAI with mapping information for S-NSSAI-2 mapping to S-NSSAI-1, and the UE triggers the implicit release of the old established PDU session(s) on S-NSSAI-1. The UE releases the old established PDU session(s) after establishing the new PDU sessions on S-NSSAI-2.

Further, in aspects of the described exchanging a network slice initiated by AMF, the NSSF receives a request from the AMF that an alternative S-NSSAI to S-NSSAI-1 is required. The NSSF determines an alternative S-NSSAI (e.g., S-NSSAI-2) which is to be used to replace S-NSSAI-1. The NSSF creates configured NSSAI, allowed NSSAI, and the corresponding mapping information including the mapped S-NSSAI-2 to S-NSSAI-1. The NSSF transmits a reply to the AMF, including the alternative S-NSSAI (e.g., S-NSSAI-2) which is to be used to replace S-NSSAI-1.

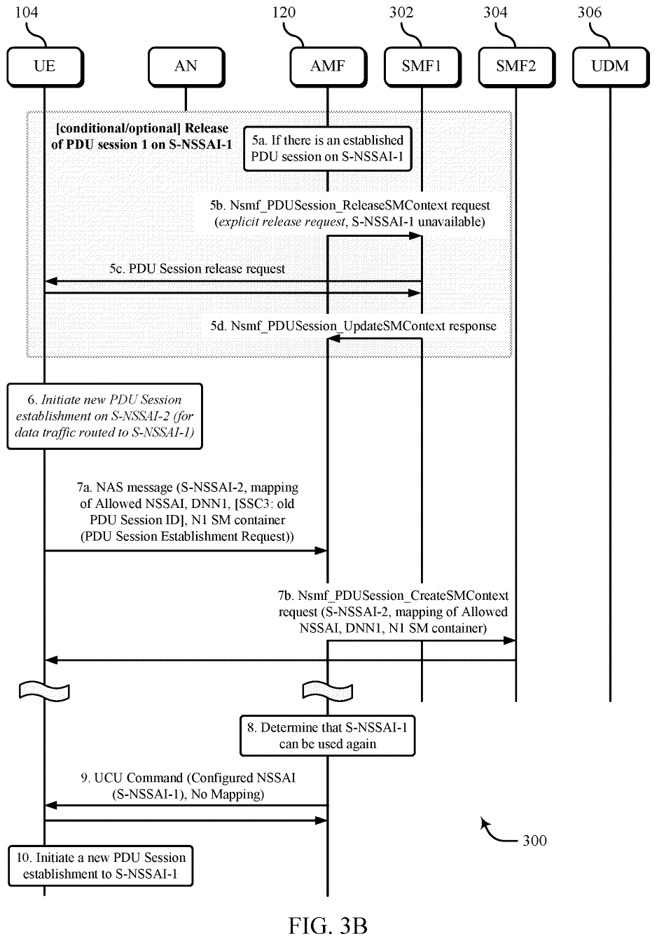

FIG. 4 illustrates an example of a block diagram 400 of a device 402 that supports exchanging a network slice initiated by AMF in accordance with aspects of the present disclosure. The device 402 may be an example of an AMF (or a network device that implements an AMF) as described herein. The device 402 may support wireless communication with one or more network entities 102, UEs 104, or any combination thereof. The device 402 may include components for bi-directional communications including components for transmitting and receiving communications, such as a processor 404, a memory 406, a transceiver 408, and an I/O controller 410. These components may be in electronic communication or otherwise coupled (e.g., operatively, communicatively, functionally, electronically, electrically) via one or more interfaces (e.g., buses).

The processor 404, the memory 406, the transceiver 408, or various combinations thereof or various components thereof may be examples of means for performing various aspects of the present disclosure as described herein. For example, the processor 404, the memory 406, the transceiver 408, or various combinations or components thereof may support a method for performing one or more of the operations described herein.

In some implementations, the processor 404, the memory 406, the transceiver 408, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 404 and the memory 406 coupled with the processor 404 may be configured to perform one or more of the functions described herein (e.g., executing, by the processor 404, instructions stored in the memory 406).

For example, the processor 404 may support wireless communication at the device 402 in accordance with examples as disclosed herein. The processor 404 may be configured as or otherwise support a means for determining that a first network slice is no longer available and can be exchanged for a second network slice; and transmitting a first signaling indicating a configuration update to a UE registered with the first network slice, the configuration update including a mapping of the second network slice to the first network slice.

Additionally, the processor 404 may be configured as or otherwise support any one or combination of the second network slice is not a UE subscribed network slice and is not identified in configured NSSAI. The configuration update to the UE includes updated configured NSSAI including the mapping of the second network slice to the first network slice. The configuration update to the UE includes allowed NSSAI including the mapping of the second network slice to the first network slice. The method further comprising transmitting a second signaling to a network session management function explicitly indicating to release one or more PDU sessions associated with the first network slice. The method further comprising receiving a second signaling from the UE as a PDU session establishment request on the second network slice. The PDU session establishment request includes the mapping of the second network slice to the first network slice, which the apparatus does not transmit to a network session management function. The method further comprising transmitting a second signaling to a network data management function indicating a request to exchange the first network slice with the second network slice based at least in part on the determining that the first network slice is no longer available; and receiving a third signaling from the network data management function identifying the second network slice to replace the first network slice. The second signaling to the network data management function initiates the network data management function to perform a network slice subscription update procedure.

Additionally, or alternatively, the device 402, in accordance with examples as disclosed herein, may include an apparatus for wireless communication, comprising a processor; and a memory coupled with the processor, the processor configured to determine that a first network slice is no longer available and can be exchanged for a second network slice; and transmit a first signaling indicating a configuration update to a UE registered with the first network slice, the configuration update including a mapping of the second network slice to the first network slice.

Additionally, the wireless communication at the device 402 may include any one or combination of the second network slice is not a UE subscribed network slice and is not identified in configured NSSAI. The configuration update to the UE includes updated configured NSSAI including the mapping of the second network slice to the first network slice. The configuration update to the UE includes allowed NSSAI including the mapping of the second network slice to the first network slice. The processor is configured to transmit a second signaling to a network session management function explicitly indicating to release one or more PDU sessions associated with the first network slice. The processor is configured to receive a second signaling from the UE as a PDU session establishment request on the second network slice. The PDU session establishment request includes the mapping of the second network slice to the first network slice, which the apparatus does not transmit to a network session management function. The processor is configured to transmit a second signaling to a network data management function indicating a request to exchange the first network slice with the second network slice based at least in part on the determination that the first network slice is no longer available; and receive a third signaling from the network data management function identifying the second network slice to replace the first network slice. The second signaling to the network data management function initiates the network data management function to perform a network slice subscription update procedure.

The processor 404 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 404 may be configured to operate a memory array using a memory controller. In some other implementations, a memory controller may be integrated into the processor 404. The processor 404 may be configured to execute computer-readable instructions stored in a memory (e.g., the memory 406) to cause the device 402 to perform various functions of the present disclosure.

The memory 406 may include random access memory (RAM) and read-only memory (ROM). The memory 406 may store computer-readable, computer-executable code including instructions that, when executed by the processor 404 cause the device 402 to perform various functions described herein. The code may be stored in a non-transitory computer-readable medium such as system memory or another type of memory. In some implementations, the code may not be directly executable by the processor 404 but may cause a computer (e.g., when compiled and executed) to perform functions described herein. In some implementations, the memory 406 may include, among other things, a basic I/O system (BIOS) which may control basic hardware or software operation such as the interaction with peripheral components or devices.

The I/O controller 410 may manage input and output signals for the device 402. The I/O controller 410 may also manage peripherals not integrated into the device M02. In some implementations, the I/O controller 410 may represent a physical connection or port to an external peripheral. In some implementations, the I/O controller 410 may utilize an operating system such as iOS®, ANDROID®, MS-DOS®, MS-WINDOWS®, OS/2®, UNIX®, LINUX®, or another known operating system. In some implementations, the I/O controller 410 may be implemented as part of a processor, such as the processor 404. In some implementations, a user may interact with the device 402 via the I/O controller 410 or via hardware components controlled by the I/O controller 410.

In some implementations, the device 402 may include a single antenna 412. However, in some other implementations, the device 402 may have more than one antenna 412 (i.e., multiple antennas), including multiple antenna panels or antenna arrays, which may be capable of concurrently transmitting or receiving multiple wireless transmissions. The transceiver 408 may communicate bi-directionally, via the one or more antennas 412, wired, or wireless links as described herein. For example, the transceiver 408 may represent a wireless transceiver and may communicate bi-directionally with another wireless transceiver. The transceiver 408 may also include a modem to modulate the packets, to provide the modulated packets to one or more antennas 412 for transmission, and to demodulate packets received from the one or more antennas 412.

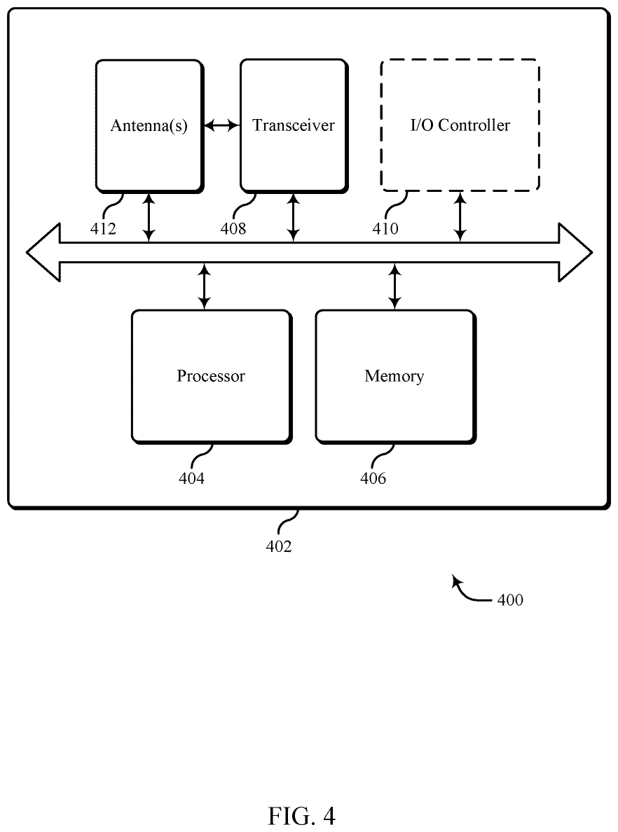

FIG. 5 illustrates an example of a block diagram 500 of a device 502 that supports exchanging a network slice initiated by AMF in accordance with aspects of the present disclosure. The device 502 may be an example of UE 104 as described herein. The device 502 may support wireless communication with one or more network entities 102, UEs 104, or any combination thereof. The device 502 may include components for bi-directional communications including components for transmitting and receiving communications, such as a processor 504, a memory 506, a transceiver 508, and an I/O controller 510. These components may be in electronic communication or otherwise coupled (e.g., operatively, communicatively, functionally, electronically, electrically) via one or more interfaces (e.g., buses).

The processor 504, the memory 506, the transceiver 508, or various combinations thereof or various components thereof may be examples of means for performing various aspects of the present disclosure as described herein. For example, the processor 504, the memory 506, the transceiver 508, or various combinations or components thereof may support a method for performing one or more of the operations described herein.

In some implementations, the processor 504, the memory 506, the transceiver 508, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 504 and the memory 506 coupled with the processor 504 may be configured to perform one or more of the functions described herein (e.g., executing, by the processor 504, instructions stored in the memory 506).

For example, the processor 504 may support wireless communication at the device 502 in accordance with examples as disclosed herein. The processor 504 may be configured as or otherwise support a means for receiving a first signaling indicating a configuration update to change from a first network slice being used for one or more PDU sessions to a second network slice, the configuration update including a mapping of the second network slice to the first network slice; and transmitting a second signaling as a new PDU session establishment request on the second network slice based at least in part on a determination to establish the new PDU session.

Additionally, the processor 504 may be configured as or otherwise support any one or combination of the second network slice is not identified in configured NSSAI. The method further comprising releasing the one or more PDU sessions based on the configuration update received to change from the first network slice to the second network slice. The one or more PDU sessions are released implicitly without subsequent signaling. The one or more PDU sessions are released after the new PDU session is established.

Additionally, or alternatively, the device 502, in accordance with examples as disclosed herein, may include an apparatus for wireless communication, comprising a processor; and a memory coupled with the processor, the processor configured to receive a first signaling indicating a configuration update to change from a first network slice being used for one or more PDU sessions to a second network slice, the configuration update including a mapping of the second network slice to the first network slice; and transmit a second signaling as a new PDU session establishment request on the second network slice based at least in part on a determination by the apparatus to establish the new PDU session.

Additionally, the wireless communication at the device 502 may include any one or combination of the processor is configured to identify an absence of the second network slice in configured NSSAI. The processor is configured to release the one or more PDU sessions based on the configuration update received to change from the first network slice to the second network slice. The processor is configured to implicitly release the one or more PDU sessions without subsequent signaling. The processor is configured to release the one or more PDU sessions after the new PDU session is established.

The processor 504 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 504 may be configured to operate a memory array using a memory controller. In some other implementations, a memory controller may be integrated into the processor 504. The processor 504 may be configured to execute computer-readable instructions stored in a memory (e.g., the memory 506) to cause the device 502 to perform various functions of the present disclosure.

The memory 506 may include random access memory (RAM) and read-only memory (ROM). The memory 506 may store computer-readable, computer-executable code including instructions that, when executed by the processor 504 cause the device 502 to perform various functions described herein. The code may be stored in a non-transitory computer-readable medium such as system memory or another type of memory. In some implementations, the code may not be directly executable by the processor 504 but may cause a computer (e.g., when compiled and executed) to perform functions described herein. In some implementations, the memory 506 may include, among other things, a basic I/O system (BIOS) which may control basic hardware or software operation such as the interaction with peripheral components or devices.

The I/O controller 510 may manage input and output signals for the device 502. The I/O controller 510 may also manage peripherals not integrated into the device M02. In some implementations, the I/O controller 510 may represent a physical connection or port to an external peripheral. In some implementations, the I/O controller 510 may utilize an operating system such as iOS®, ANDROID®, MS-DOS®, MS-WINDOWS®, OS/2®, UNIX®, LINUX®, or another known operating system. In some implementations, the I/O controller 510 may be implemented as part of a processor, such as the processor 504. In some implementations, a user may interact with the device 502 via the I/O controller 510 or via hardware components controlled by the I/O controller 510.

In some implementations, the device 502 may include a single antenna 512. However, in some other implementations, the device 502 may have more than one antenna 512 (i.e., multiple antennas), including multiple antenna panels or antenna arrays, which may be capable of concurrently transmitting or receiving multiple wireless transmissions. The transceiver 508 may communicate bi-directionally, via the one or more antennas 512, wired, or wireless links as described herein. For example, the transceiver 508 may represent a wireless transceiver and may communicate bi-directionally with another wireless transceiver. The transceiver 508 may also include a modem to modulate the packets, to provide the modulated packets to one or more antennas 512 for transmission, and to demodulate packets received from the one or more antennas 512.

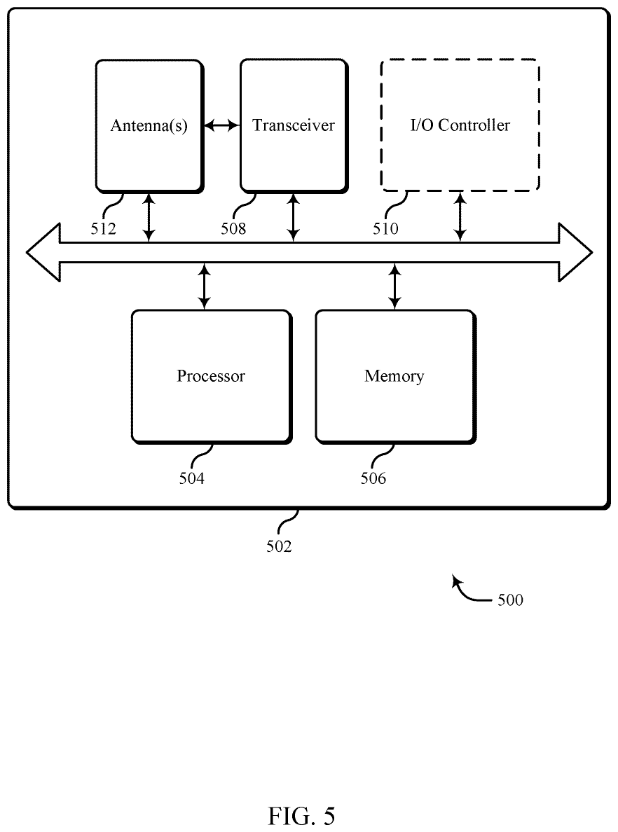

FIG. 6 illustrates a flowchart of a method 600 that supports exchanging a network slice initiated by AMF in accordance with aspects of the present disclosure. The operations of the method 600 may be implemented by a device or its components as described herein. For example, the operations of the method 600 may be performed by an AMF (or a network device that implements an AMF) as described with reference to FIGS. 1 through 5. In some implementations, the device may execute a set of instructions to control the function elements of the device to perform the described functions. Additionally, or alternatively, the device may perform aspects of the described functions using special-purpose hardware.

At 602, the method may include determining that a first network slice is no longer available and can be exchanged for a second network slice. The operations of 602 may be performed in accordance with examples as described herein. In some implementations, aspects of the operations of 602 may be performed by a device as described with reference to FIG. 1.

At 604, the method may include transmitting a first signaling indicating a configuration update to a UE registered with the first network slice, the configuration update including a mapping of the second network slice to the first network slice. The operations of 604 may be performed in accordance with examples as described herein. In some implementations, aspects of the operations of 604 may be performed by a device as described with reference to FIG. 1.

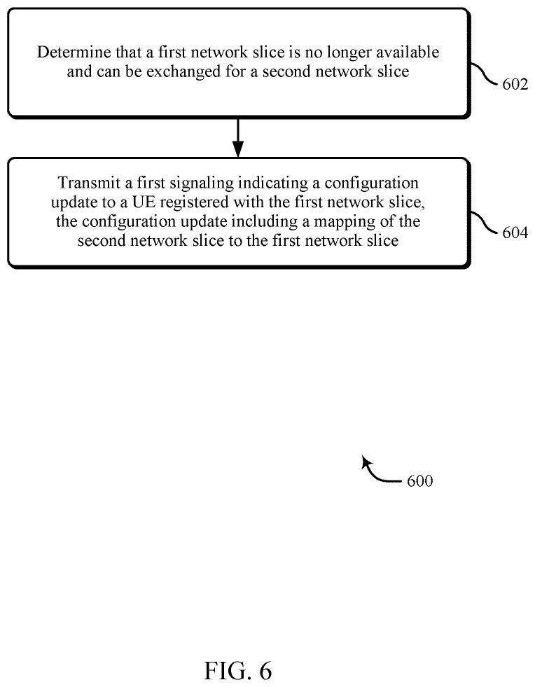

FIG. 7 illustrates a flowchart of a method 700 that supports exchanging a network slice initiated by AMF in accordance with aspects of the present disclosure. The operations of the method 700 may be implemented by a device or its components as described herein. For example, the operations of the method 700 may be performed by an AMF (or a network device that implements an AMF) as described with reference to FIGS. 1 through 5. In some implementations, the device may execute a set of instructions to control the function elements of the device to perform the described functions. Additionally, or alternatively, the device may perform aspects of the described functions using special-purpose hardware.

At 702, the method may include transmitting a signaling to a network session management function explicitly indicating to release one or more PDU sessions associated with the first network slice. The operations of 702 may be performed in accordance with examples as described herein. In some implementations, aspects of the operations of 702 may be performed by a device as described with reference to FIG. 1.

At 704, the method may include receiving a signaling from the UE as a PDU session establishment request on the second network slice. The operations of 704 may be performed in accordance with examples as described herein. In some implementations, aspects of the operations of 704 may be performed by a device as described with reference to FIG. 1.

At 706, the method may include transmitting a signaling to a network data management function indicating a request to exchange the first network slice with the second network slice based on the determining that the first network slice is no longer available. The operations of 706 may be performed in accordance with examples as described herein. In some implementations, aspects of the operations of 706 may be performed by a device as described with reference to FIG. 1.

At 708, the method may include receiving a signaling from the network data management function identifying the second network slice to replace the first network slice. The operations of 708 may be performed in accordance with examples as described herein. In some implementations, aspects of the operations of 708 may be performed by a device as described with reference to FIG. 1.

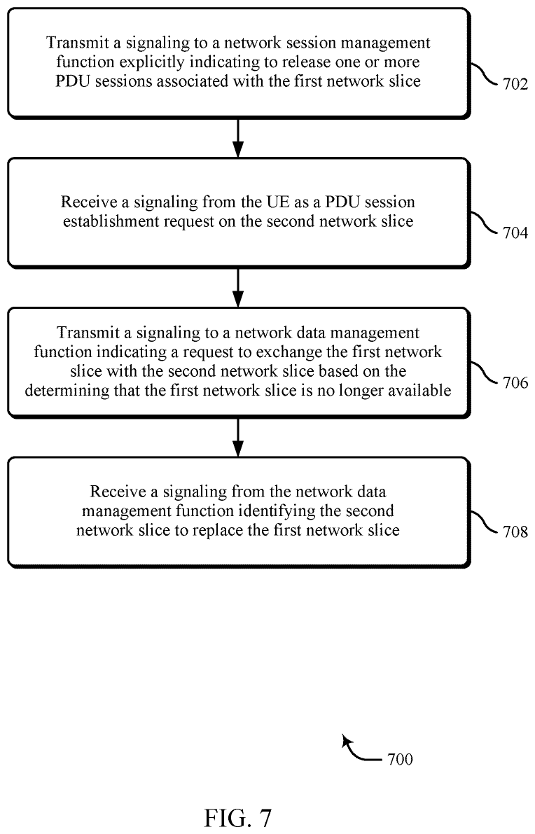

FIG. 8 illustrates a flowchart of a method 800 that supports exchanging a network slice initiated by AMF in accordance with aspects of the present disclosure. The operations of the method 800 may be implemented by a device or its components as described herein. For example, the operations of the method 800 may be performed by a UE 104 as described with reference to FIGS. 1 through 5. In some implementations, the device may execute a set of instructions to control the function elements of the device to perform the described functions. Additionally, or alternatively, the device may perform aspects of the described functions using special-purpose hardware.

At 802, the method may include receiving a first signaling indicating a configuration update to change from a first network slice being used for one or more PDU sessions to a second network slice, the configuration update including a mapping of the second network slice to the first network slice. The operations of 802 may be performed in accordance with examples as described herein. In some implementations, aspects of the operations of 802 may be performed by a device as described with reference to FIG. 1.

At 804, the method may include transmitting a second signaling as a new PDU session establishment request on the second network slice based at least in part on a determination to establish the new PDU session. The operations of 804 may be performed in accordance with examples as described herein. In some implementations, aspects of the operations of 804 may be performed by a device as described with reference to FIG. 1.

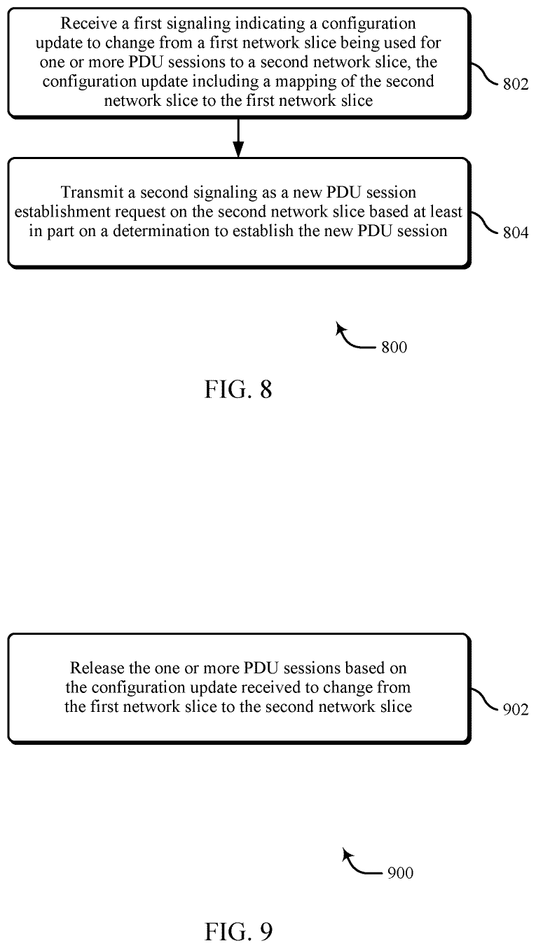

FIG. 9 illustrates a flowchart of a method 900 that supports exchanging a network slice initiated by AMF in accordance with aspects of the present disclosure. The operations of the method 900 may be implemented by a device or its components as described herein. For example, the operations of the method 900 may be performed by a UE 104 as described with reference to FIGS. 1 through 5. In some implementations, the device may execute a set of instructions to control the function elements of the device to perform the described functions. Additionally, or alternatively, the device may perform aspects of the described functions using special-purpose hardware.

At 902, the method may include releasing the one or more PDU sessions based on the configuration update received to change from the first network slice to the second network slice. The operations of 902 may be performed in accordance with examples as described herein. In some implementations, aspects of the operations of 902 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of one or more of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A network device for wireless communication, comprising:
at least one memory; and
at least one processor coupled with the at least one memory and configured to cause the network device to:
determine that a first network slice is no longer available and can be exchanged for a second network slice; and
transmit a first signaling indicating a configuration update to a user equipment (UE) registered with the first network slice, the configuration update including a mapping of the second network slice to the first network slice.

2. The network device of claim 1, wherein the second network slice is not a UE subscribed network slice and is included in configured network slice selection assistance information (NSSAI).

3. The network device of claim 1, wherein the configuration update to the UE includes at least one of:
updated configured network slice selection assistance information (NSSAI) including the mapping of the second network slice to the first network slice; or
allowed NSSAI including the mapping of the second network slice to the first network slice.

4. The network device of claim 1, wherein the at least one processor is configured to cause the network device to transmit a second signaling to a network session management function explicitly indicating to release one or more protocol data unit (PDU) sessions associated with the first network slice.

5. The network device of claim 1, wherein the at least one processor is configured to cause the network device to receive a second signaling from the UE as a protocol data unit (PDU) session establishment request on the second network slice.

6-7. (canceled)

8. A user equipment (UE) for wireless communication, comprising:
at least one memory; and
at least one processor coupled with the at least one memory and configured to cause the UE to:
receive a first signaling indicating a configuration update to change from a first network slice being used for one or more protocol data unit (PDU) sessions to a second network slice, the configuration update including a mapping of the second network slice to the first network slice;
and
transmit a second signaling as a new PDU session establishment request associated with the second network slice and the first network slice.

9. The UE of claim 8, wherein the at least one processor is configured to cause the UE to identify an absence of the second network slice in configured network slice selection assistance information (NSSAI).

10. The UE of claim 8, wherein the at least one processor is configured to cause the UE to release the one or more PDU sessions based on the configuration update received to change from the first network slice to the second network slice.

11. The UE of claim 10, wherein the at least one processor is configured to cause the UE to at least one of implicitly release the one or more PDU sessions without subsequent signaling, or release the one or more PDU sessions after the new PDU session is established.

12. (canceled)

13. A method performed by a network device, the method comprising:
determining that a first network slice is no longer available and can be exchanged for a second network slice; and
transmitting a first signaling indicating a configuration update to a user equipment (UE) registered with the first network slice, the configuration update including a mapping of the second network slice to the first network slice.

14. The method of claim 13, wherein the second network slice is not a UE subscribed network slice and is included in configured network slice selection assistance information (NSSAI).

15. The method of claim 13, wherein the configuration update to the UE includes at least one of:
updated configured network slice selection assistance information (NSSAI) including the mapping of the second network slice to the first network slice; or
allowed NSSAI including the mapping of the second network slice to the first network slice.

16. The method of claim 13, further comprising transmitting a second signaling to a network session management function explicitly indicating to release one or more protocol data unit (PDU) sessions associated with the first network slice.

17. The method of claim 13, further comprising receiving a second signaling from the UE as a protocol data unit (PDU) session establishment request on the second network slice, wherein the PDU session establishment request includes the mapping of the second network slice to the first network slice, which is not transmitted to a network session management function.

18-20. (canceled)

21. The UE of claim 8, wherein:
the first signaling includes a mapping of visited public land mobile network (VPLMN) single network slice selection assistance information (S-NSSAI) to VPLMN alternative S-NSSAI; and
the second signaling includes both the VPLMN alternative S-NSSAI and the VPLMN S-NSSAI.

22. The UE of claim 8, wherein:
the first signaling includes a mapping of home public land mobile network (HPLMN) single network slice selection assistance information (S-NSSAI) to a HPLMN alternative S-NSSAI; and
the second signaling includes both the HPLMN alternative S-NSSAI and the HPLMN S-NSSAI.

23. A method performed by a user equipment (UE), the method comprising:
receiving a first signaling indicating a configuration update to change from a first network slice being used for one or more protocol data unit (PDU) sessions to a second network slice, the configuration update including a mapping of the second network slice to the first network slice; and
transmitting a second signaling as a new PDU session establishment request associated with the second network slice and the first network slice.

24. The method of claim 23, further comprising:
identifying an absence of the second network slice in configured network slice selection assistance information (NSSAI); and
releasing the one or more PDU sessions based on the configuration update received to change from the first network slice to the second network slice.

25. The method of claim 23, wherein:
the first signaling includes a mapping of visited public land mobile network (VPLMN) single network slice selection assistance information (S-NSSAI) to VPLMN alternative S-NSSAI; and
the second signaling includes both the VPLMN alternative S-NSSAI and the VPLMN S-NSSAI.

26. The method of claim 23, wherein:
the first signaling includes a mapping of home public land mobile network (HPLMN) single network slice selection assistance information (S-NSSAI) to a HPLMN alternative S-NSSAI; and
the second signaling includes both the HPLMN alternative S-NSSAI and the HPLMN S-NSSAI.
